(19) United States
(12) Patent Application Publication
(10) Pub. No.: US 2005/0275854 A1
(43) Pub. Date: Dec. 15, 2005

(54) Method for confirming correct selection of an input profile for a color printer

(75) Inventor: Martin Bailey, Comberton (GB)

Correspondence Address: DARBY & DARBY P.C., P. O. BOX 5257, NEW YORK, NY, 10150-5257, US

(73) Assignee: Global Graphics Software Limited

(21) Appl. No.: 10/342,161

(22) Filed: Jan. 14, 2003

(51) Int. Cl. H04N 1/52; H04N 1/60

(52) U.S. Cl. 358/1.9; 358/504; 358/518

(57) ABSTRACT

A method for permitting a user of a printer, such as a color proofing printer, to rapidly and easily evaluate whether or not the color of prints produced by the printer is correct by comparing different pairs of test patches added to the intended content of a print job. As a result, it becomes possible to determine whether the print was produced using a correct input configuration.

### BACKGROUND OF THE INVENTION

1. Field of the Invention

The invention relates to the field of computer graphics and, more particularly, to a method for confirming a correct selection of an input profile for pre-press workflows.

2. Description of the Related Art

The use of color printers for producing draft prints or “proofs” from digital files in the graphic arts industry is increasing rapidly. The same digital files are later used to produce the necessary plates, screens, cylinders or other master copies of the pages for use in producing the final printed piece.

In some cases, the proof is intended to provide only a rough idea of the color of its final reproduction, but in others the proof is treated as an accurate prediction of the color of the final printed piece. Such accurate proofs are sometimes referred to as “contract proofs” because they form part of the contract between a printing company that will print a job on their presses and their clients, who have designed and created the job as digital files.

When configuring a color printer to produce accurate color output it is almost always necessary to apply some form of color management technology. This is most often achieved using color profiles that conform to the specification published by the International Color Consortium (ICC). A color profile must be selected based on the output conditions, which include the printer model being used, the media (often paper) that will be printed on, the resolution at which the printing is performed, and the ink or color donors that will be used to create an image on the media.

The printing press that will be used for the final printed piece typically has very different color characteristics than the printer employed to produce proofs. If the proof is to provide an accurate prediction of the color of the trusted printed piece, then an additional profile must be selected in order to provide a description of the press characteristics, often in the form of an additional color profile. This add ional profile is then applied to an “input” side of a color management scheme to convert data in a device dependent color space, usually that of the printing press, into a device independent color space.

The most common device dependent color space in printing uses the four colorants, i.e., Cyan, Magenta, Yellow and Black, and is usually referred to as CMYK. Other such spaces include RGB (Red, Green and Blue colorants).

A device independent color space allows a color to be defined in an absolute way, without reference to how a particular printer, monitor or other output device might render the color space.

It will be apparent to one of ordinary skill in the art that there are a large number of steps that a user of such a color printer must follow in order to produce a proof that provides an accurate prediction of the color of the final printed piece. Confidence in correct configuration is an important enabler for the use of RGB color spaces, such as the sRGB standard (as set forth in International Electrotechnical Commission (IEC) Standard 61966), and characterized CMYK printing conditions, such as those set out in “Technical Report 1” from the Committee for Graphic Arts Technical Standards, the body tasked with developing standards for graphic arts in the USA by the American National Standards Institute (ANSI/CGATS TR001) and in the International Standard (ISO) 12647. It is therefore important that a mechanism be provided to validate that each of the correct steps were taken, and that the correct color profile (or other mechanism for specifying color behavior) was selected.

These same requirements also apply in those cases where color management is applied during processing of digital files for final print reproduction. This is occasionally performed for work printed on conventional impact presses (whether using offset lithography, gravure, screen printing, etc.), but is more common when printing on non-impact digital presses using technologies such as dry toner or ink-jet to directly image onto paper or some other media.

It is a common practice to add a number of color patches to prints outside the area of the page that will be produced on the final printed and trimmed piece. Such collections of patches are usually described as “color bars” or “control strips.” Some visual assessment of the accuracy of a print may be made from a well constructed color bar. However, when evaluating a print it is necessary to measure patches with an instrument, such as a colorimeter or spectrophotometer, or to compare the patches with sample patches known to be correct to properly ascertain whether a printer was correctly configured.

Colorimeters and spectrophotometers are expensive, as well as slow to use. Often there is a clear correlation between the speed of checking color patches and the cost of the instrument. A device that is capable of operating quickly enough for use in a production environment will often cost more than is readily justifiable.

Sample test sheets of color patches known to be of the correct color that are provided for comparison with the color bar on the proof have a rather short life span. Many will fade, or darken, or the color will change in some way as they age. This is particularly true when the color patches are left in daylight. Such changes render the patches useless for evaluating the color of prints. The provision of such patches for comparison also means that the tool set of which they form a part, must be supplied in physical form to a new site to which the tool set is sold or otherwise provided, rather than using a faster and cheaper electronic delivery method.

### SUMMARY OF THE INVENTION

The present invention is a method for electronically expressing colored patches such that a user can confirm whether a current selection of an input profile is correct. Here, a first criterion for determining a number of patches and their colors is that a reasonable coverage of the color gamut of the printer is represented. In particular, all colorants used by the printer to produce an image are included in the criterion, such that errors in a color profile or in the calibration of the printer that affect only one colorant are identified.

A second criterion for choosing the patches and their colors is that colors which are especially critical for assessing the accuracy of the color of a print must be included. Typically, the second criterion will ensure that colors similar to natural skin tones are also included in the color patches. Where specific colors are commonly used, and it is important they are reproduced accurately, such as in a corporate logo, these colors must also be included in the patches.

In accordance with the present invention, two patches for each chosen color are encoded within a page description. The two patches are each encoded differently, and placed next to each other so that when they are printed, any differences between them become immediately apparent.

The color of a first patch in each pair of patches is expressed using a device independent color space as specified by the international body that defines basic specifications related to the perception of light and color, i.e., Commission International de l'Eclerage (CIE). Here, the color in the first patch in each pair of patches is expressed using color spaces such as “CIE XYZ” or “CIE L*a*b*.” By definition, the rendering of these patches is only affected by the output profile that is selected and the calibration that is applied to each colorant used to image the patches onto the medium.

Next, the second patch in each pair of patches is encoded in a device dependent color space. This is typically CMYK. In certain embodiments, the second patch is encoded in RGB, Hexachrome® (a registered trademark of Pantone, Inc.), or the like. The second patches will be reproduced according to the configuration of the printer and its associated raster image processor. In one printer configuration, the color is passed directly to the proofing device as device code values (tint values of the colorants actually used on the device). In another printer configuration, the color is converted to the actual device color space of the proofing device. This is performed using any mechanism that is available to the printer operator, such as an RGB to CMYK transformation that is described in standard PostScript Language Reference Manuals. Another printer configuration intercepts the device dependent colors in a color management system for conversion into a device independent color space.

Each printer, i.e., the device, renders marks on a page in a variety of color inks, such as Cyan, Magenta, Yellow and Black colors may therefore be defined by specifying the percentage of complete coverage of the paper or other media for each of those inks, such as when something is drawn having a 30% coverage of Cyan, a 20% Magenta, and no Yellow and no Black, a Greenish/Blue color is achieved. However, exactly what color is achieved depends on which device is being used for printing because the color of the Cyan colorant on each device slightly differs. In addition, the way in which the colorants interact with each other on each device also slightly differs. The description of exactly what color is obtained based on certain percentages of ink coverage for each of the colorants is a color space. It follows that the color space obtained on a particular device when the sets of ink coverage's for the different colorants are used is the device color space.

In accordance with the invention, the rendition of the second device dependent patches will also be influenced by calibration and, in some printer configurations, by an output profile, in much the same manner as the way in which the first device independent patches are influenced. The rendition of the device dependent patches will also be affected by the mechanism used to transform colors expressed in device dependent color spaces to device code values. If a color management system is in use, this will include the selection of an input profile. Any difference between the device dependent and device independent patches therefore indicates that that transformation of device dependent color spaces did not perform in the manner expected by the designer or pre-press operator. A visual comparison of the first and second patch in each pair of patches therefore provides a rapid, accurate visual check of the correctness of the print color.

In many cases it is possible to specify a color that cannot be printed on the selected device, perhaps because it's too bright or too dark. The color management systems used by printers can compensate for such colors by compressing the set of specifiable colors into the set of colors (or gamut) of the printing device. A variety of different approaches to gamut compression can be used that are appropriate for different situations; some are better for photographic images, and others are better for corporate identity colors, for instance. These different approaches are called rendering intents.

Some printing systems are therefore capable of rendering intentionally different colors for the same nominal color for marks drawn using vector commands and those drawn as images or rasters. Typically, there are different criteria for objects that are drawn in vector and gamut based data or raster data. As a result, it becomes desirable to apply different criteria for the objects drawn in vector and gamut based data or raster data based on the different rendering intents that are applied. Color differences between vector and raster encodings arise in the output side of the color management and are therefore immaterial in determining whether the input side has been correctly configured. When different rendering intents are necessary, two pairs of patches are provided for each color that is chosen; one pair is drawn using vectors and the other pair is drawn using rasters. Comparison of the printed patches is then performed independently for each pair.

In accordance with the present invention, the color patches are configured such that, when the colors are rendered on a printer that is incorrectly configured for the intended device dependent color spaces for which the job was designed, they automatically produce a color different from that against which it is being visually compared.

In addition, the invention does not require instrumentation. The color patches are added to the margins of the electronic representation of a page, part of a page, or collection of pages that are also expressed using a page description language, printer command language or other suitable file format. The patches are thus included on the printed representation of a page, part of a page, or collection of pages.

When the page, partial page or collection of pages is printed, the two colors of each pair of test patches are visually compared with each other. Any significant differences in color in any pair of test patches on the print indicate that the printer configuration is incorrect. As a result, the user is provided with a way to detect whether or not the print provides an accurate representation of the colors selected for electronic representation of printed material.

### BRIEF DESCRIPTION OF THE DRAWINGS

The foregoing and other advantages and features of the invention will become more apparent from the detailed description of the preferred embodiment of the invention given below with reference to the accompanying drawings in which:

FIG. 1 is a monochromatic illustration of a set of patches printed in accordance with the invention when the colors in each of the pairs of patches match;

FIG. 2 is a monochromatic illustration of the patches printed in accordance with the invention when the colors in each of the pairs of patches do not match; and

FIGS. 3(a) and 3(b) form a flow chart illustrating the steps of the method in accordance with the invention.

### DETAILED DESCRIPTION OF THE EXEMPLARY EMBODIMENTS

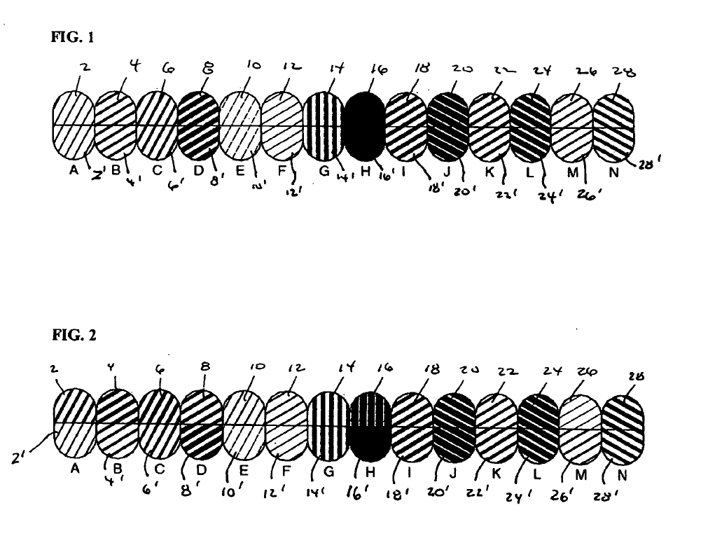

FIG. 1 is an exemplary illustration of a result that is obtained if the correct input profile has been selected prior to printing a page. Here, a color is represented figuratively by the use of different hatching patterns. In accordance with the invention, a fragment of page description is provided and used to draw multiple colors selected from the Pantone® coated swatch code book developed by Pantone®, Inc.

With further reference to FIG. 1, a first criterion for determining a number of patches A thru N and their colors 2,2′ thru 28,28′ is that a reasonable coverage of the color gamut of the printer is represented. In particular, all colorants used by the printer to produce an image are included in the criterion, such that errors in a color profile or in the calibration of the printer that affect only one colorant are identified.

A second criterion for choosing the patches A thru N and their colors 2,2′ thru 28,28′ is that colors which are especially critical for assessing the accuracy of the color of a print must be included. Typically, the second criterion will ensure that colors similar to natural skin tones are also included in the color patches. Where specific colors are commonly used, and it is important they are reproduced accurately, such as in a corporate logo, these colors must also be included in the patches.

In accordance with the invention, two patches (e.g., 2 and 2′) for each chosen color are encoded within a page description. The two patches are each encoded differently, and placed next to each other so that when they are printed, any differences between them become immediately apparent.

The color of a first patch, e.g. 2 thru 28, in each pair of patches e.g., A thru N, is expressed using a device independent color space. Here, the color in the first patch in each pair of patches is expressed using color spaces such as “CIE XYZ” or “CIE L*a*b*.” By definition, the rendering of these patches is only affected by the output profile that is selected and the calibration that is applied to each colorant used to image the patches onto the medium.

Next, the second patch, e.g., 2′ thru 28′ in each pair of patches is encoded in a device dependent color space. This is typically CMYK. In certain embodiments, the second patch is encoded in RGB, Hexachrome® (a registered trademark of Pantone, Inc.), or the like. The second patches (e.g., 2′ thru 28′) will be reproduced according to the configuration of the printer and its associated raster image processor. In one printer configuration, the color is passed directly to the proofing device as device code values (tint values of the colorants actually used on the device). In another printer configuration, the color is converted to the actual device color space of the proofing device. This is performed using any mechanism that is available to the printer operator, such as an RGB to CMYK transformation that is described in standard PostScript Language Reference Manuals. Another printer configuration intercepts the device dependent colors in a color management system for conversion into a device independent color space.

In preferred embodiments, several pairs of patches are drawn, where the same nominal color is used for both patches in the pair. The first patch in each pair of patches is expressed using a device independent color space, and the second patch in each pair is expressed using the device dependent color space that corresponds to the expected final printing process to be used. In preferred embodiments, two pairs of patches for each nominal color are used. Here, both the patches in the first of these pairs of patches is encoded using vector drawing commands, and both patches in the second of these pairs of patches is encoded using raster image commands. If different rendering intents are applied to vector and raster objects, then a different color will be obtain on the final print. Within each pair, the same color should be obtained, independent of whether the patch was encoded using vector drawing commands or raster image commands.

Preferably, the page description language is the PostScript® language developed by Adobe® Systems, Inc. In another embodiment, the page description language is the Portable Document Format (PDF).

An exemplary software code, expressed as an encapsulated PostScript file, to draw the preferred fragment of page description is as follows:

```
%!PS-Adobe-EPS
%%Title: Sample CMYK color bar
%%Date: 11 June 2002
%%BoundingBox: 0 0 254 46
% Copyright Global Graphics Software Ltd, 2002. All Rights Reserved
%%EndComments
4 dict begin
0 setgray
16 40 moveto
/Helvetica 8 selectfont
(CMYK in this job was constructed for SWOP \(CGATS TR001\)) show
/A (A)0 get def
/s 1 string def
/Helvetica 6 selectfont
0 1 13 {
  dup 18 mul 8 add 0.25 moveto
  //s dup 0 4 −1 roll //A add put show
} for
1 22 translate
false setoverprint
% No need to set rendering intent - it will be applied
% equally to LAB data and to intercepted CMYK.
%
% Do NOT set CMYK interception, these patches must use
% the same config as the rest of the job.
/DecodeCore {
  dup 0.2069 lt {
    0.1379 sub 0.1284 mul
  }  {
    dup dup mul mul
  } ifelse
} bind def
/LABSpace [
  /CIEBasedABC
    <<
    /RangeABC [ 0 100 −128 127 −128 127 ]
    /DecodeABC [
      { 16 add 116 div } bind
      { 500 div } bind
      { 200 div } bind
    ]
    /MatrixABC [ 1 1 1 1 0 0 0 0 −1 ]
    /DecodeLMN [
        {
        //DecodeCore exec
        0.9642 mul
      } bind
      //DecodeCore
        {
        //DecodeCore exec
        0.8249 mul
      } bind
    ]
    /WhitePoint [0.9642 1 0.8249]
  >>
] def
% Use a 100×100 image to avoid ‘clever’ code
% special casing it.
/IDict <<
  /ImageType 1
  /Width 100
  /Height 100
  /ImageMatrix [ 0.09 0 0 0.15 0 0 ]
  /DataSource 10000 string  % all 0 filled.
  /BitsPerComponent 8
  /Decode [ 0 1 ]
>> def
% Testings SWOP.
  [
  [ .5 0 0 0 79 −21 −27 ]
  [ 1 0 0 0 64 −41 −48 ]
  [ 0 .5 0 0 75 37 −5 ]
  [ 0 1 0 0 54 76 −7 ]
  [ 0 0 .5 0 97 −4 45 ]
  [ 0 0 1 0 95 −6 90 ]
  [ 0 0 0 .5 63 0 −2 ]
  [ 0 0 0 1 22 1 0 ]
  [ .5 .5 0 0 58 12 −29 ]
  [ 1 1 0 0 31 20 −48 ]
  [ 0 .5 .5 0 73 33 30 ]
  [ 0 1 1 0 54 70 45 ]
  [.5 0 .5 0 76 −29 15 ]
  [ 1 0 1 0 59 −68 27 ]
]  {
  aload pop
  gsave
  % use an indexed color space to make the image easier.
  [ /Indexed //LABSpace 1 [ /pop load 9 −3 roll ] cvx bind ]
  setcolorspace
  0 setcolor
  0 0 moveto
  18 0 lineto
  9 −6 9 0 180 arcn
  closepath
  gsave fill grestore clip
  9 −15 translate
  //IDict image
  grestore
  gsave
  [ /Indexed /DeviceCMYK 1 [ /pop load 10 −4 roll ] cvx bind ]
  setcolorspace
  0 setcolor
  0 0 moveto
  18 0 lineto
  9 6 9 0 180 arc
  closepath
  gsave fill grestore clip
  9 0 translate
  //IDict image
  grestore
  18 0 translate
} bind forall
showpage
end
%%EOF
```

In accordance with the preferred embodiment of the present invention, a pre-press operator configures the controller of his printer to add the fragment of page description to the margin of each page printed. In alternative embodiments, the operator adds the fragment to the edge of a sheet when designing the layout of pages on each sheet for printing. In certain embodiments, the fragment is included as part of the print job. Each time that a page is subsequently printed, the marks expressed by the page collection of pages on a sheet.

On completion of printing, the operator visually observes each pair of color patches to determine whether they match. However, a comparison between patches encoded using vector drawing commands and those encoded using raster image commands is not made. Instead, each patch is compared only with the other patch that is contained in its own pair of patches.

With reference to FIG. 1, if the marks are printed as illustrated, i.e., the color of the first patch 2 thru 28 of each pair of test patches A thru N match the respective second patch 2′ thru 28′ of the pair, then the operator can conclude that the configuration of the printer is correct, and no further action needs to be taken. A prediction that the printer is correctly configured is determined independently from whether the print is a proof or a final print.

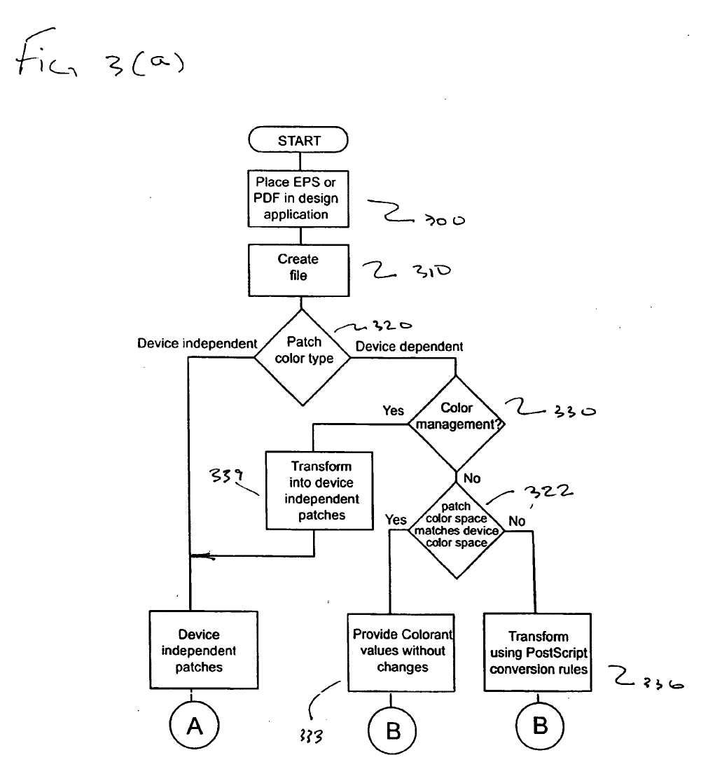

On the other hand, if the marks are printed in the manner illustrated in FIG. 2, wherein the respective colors of the patches 2,2′ thru 28,28′ in each pair A thru N do not match, then the operator can conclude that the configuration is incorrect and take steps to correct the printer configuration and reprint the page. The printer configuration may be corrected either by selecting a different input profile, or by some other means devised by the manufacturer of the printer. In the example shown in FIG. 2, the differences are seen most clearly in pairs D, H and J.

In accordance with the preferred embodiment of the invention, the International Color Consortium (ICC) color management convention is used, and an ICC based management workflow is assumed. However, there are other processing models in use, and it is not the intention of the inventor to limit the scope of the invention to the above described models. In other embodiments, the processes are grouped together within a Raster Image Processor (RIP) such that the method of the invention is performed in two or more discrete applications, such as those based on ICC profiles and ICC engines.

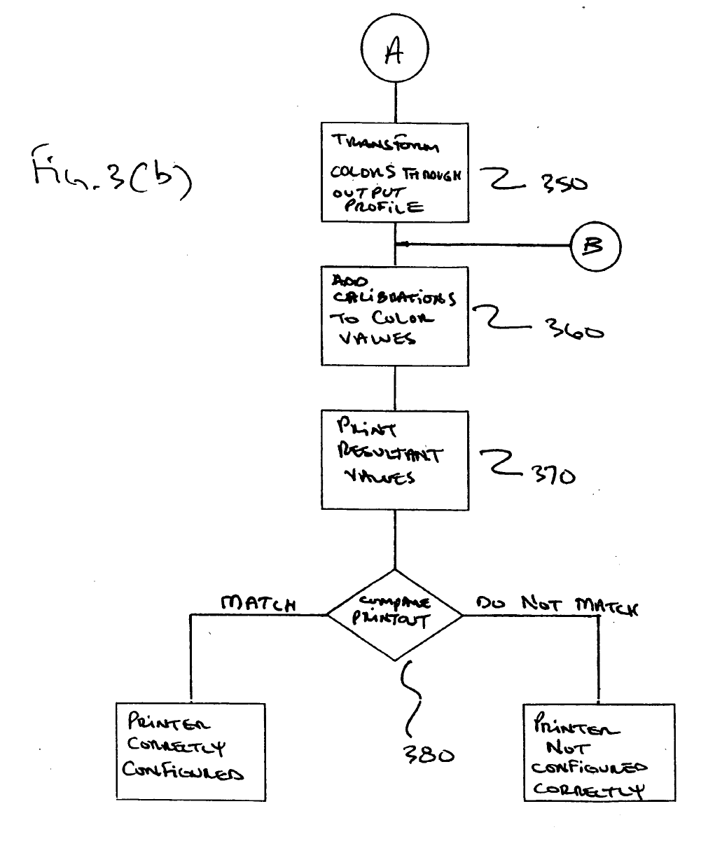

FIGS. 3(a) and 3(b) form an illustration of the steps of the method of the invention. Here, the method is implemented when a designer places an electronic PostScript file (EPS) on the page of the design application, such as Adobe Illustrator®, InDesign®, QuarkXPress®, or the like, outside of the live area, i.e., the parts of the page that will appear in the final, printed piece, as indicated in step 300 (FIG. 3(a)). Typically, most designers place a number of items, such as color bars and text, on the edge of the page that list the client name, job ID, and the like.

When producing an in-house print job, the designer or pre-press company then creates at least a PostScript® file or a PDF file of the document, as indicated in step 310. The PostScript® file is generally obtained in the design application, such as in Microsoft Word or QuarkXPress®, or the like. The PostScript® file is created when a user hits a “print” button in a print dialog box for a selected PostScript® printer. The file is then fed into a pre-press workflow, i.e., a sequence of software applications that typically includes an imposition program for appropriately laying out the pages on each printing plate, and the RIP that is used to convert the page description language into the raster format required by the output device itself. In certain embodiments, the Encapsulated PostScript file (EPS) is automatically included in the output by the imposition program. In other embodiments, the EPS is added to the output by the RIP. However the PostScript® or PDF file is generated/produced, and whatever pre processing is applied to the PostScript or PDF file, the same processing is applied, once either the PostScript file or the PDF file reaches the RIP.

Next, every element of the page is examined to determine whether that element is defined in a device dependent color space or a device independent color space, as indicated in step 320. This step is an integral part of the interpretation of a PostScript or PDF file by the RIP. The processing of colors in the device dependent patches is different from that of the colors in device independent patches. Different RIPs, and even the same RIP with different configurations, can apply several different transformations to the device dependent colors.

In accordance with the exemplary embodiments of the invention, if the page is defined in a device dependent color space, a check is made to determine whether color management is in use, as indicated in step 330.

If color management is not in use, a check is then made to determine the characteristics of the device dependent patches in the PostScript file or the PDF file , as indicated in step 332.

If the device dependent patches are the same, i.e., they use the same colorants as the output device (e.g., patches defined in CMYK being printed on a CMYK device), then any colorant values that are supplied bypass transformation through any color management profiles, as indicated in step 333.

If the device dependent patches are not the same, i.e., they use colorants that are different than the colorants used by the output device (e.g., patches defined in RGB being printed on a CMYK device), then supplied color values may be transformed using the very simple rules that are defined in the PostScript Language reference manual and converted to the output device space, as indicated in step 336. There are other similar approaches that are used for transforming CMYK values for printing applications, such as Hexachrome® for printing on a proofing device that employs six (6) colorants. Such transformations are not described in the PostScript manual, but are similar in concept to those disclosed in the manual.

Even if the device dependent patches use nominally the same colorants as those that will be applied when printing, there may be significant differences between the colors of the colorants involved. For example, the Black colorant (ink) in commonly used Epson ink jet printers tends to be much warmer (i.e., has more red/brown hues) than the Black colorant (ink) used on most printing presses, such as a Heidelberg Speedmaster. On the other hand, the Yellow used in the printing condition characterized and set out in ANSI/CGATS TR001, and based on the commonly used press conditions set out by the Specifications for Web Offset Printing organization (SWOP), is much greener than the Yellow used in most ink-jet printers. It is not possible to convert between the resulting color spaces by adjusting each colorant separately. In such a case, the incoming device dependent colors are most commonly transformed into a device independent space with the same gamut as was assumed when the original patch was constructed. Hence, if the RIP is using color management, i.e., where the colorants on the printer are significantly different from the colors of the printing press, then the incoming device dependent patches are transformed into a device independent color space, as indicated in step 339. In certain embodiments, the transformation is performed using an ICC profile to provide a full description of the absolute colors of the device dependent space that was assumed when the original color patch was first constructed.

If the page is defined in a device independent color space (step 320), then an ICC output profile is used to transform the device independent colors back into a device dependent color space of the printer, as indicated in step 350 (FIG. 3(b)).

Any necessary calibrations are then applied to the color values in the output device space, as indicated in step 360. The resulting adjusted colorant values are then printed, as indicated in step 370. In many cases, calibrations are applied'simply because the output from the color printer tends to be nonlinear, and it is easier to provide a good profile in the case where a correction code has been supplied. In other cases, the easiest way to maintain a printer such that a correct configuration is provided is to refrain from continually making new ICC profiles for the printer. Ideally, the easiest way to ensure that a correct configuration is provided is to recalibrate the printer to the state that it was in when the last ICC profile was made.

Normally, measurements of the processing of a single color channel are made to calibrate the printer. This is much faster and easier than performing potentially hundreds of measurements to generate a new profile. Generally, the calibrations are simply small adjustments to each color channel. For example, on one particular area on a page, there is a possibility of a 50% coverage in the raster being expressed during rendering. However, in order to achieve the appropriate color on the output device, it may be necessary to change the coverage to 40%, as well as change every other tint value for the other colorings as well.

In accordance with the embodiments of the invention, the user then makes a visual comparison of the two patches in each pair of printed patches, i.e., one device dependent and one device independent patch, as indicated in step 380. If upon performing the visual comparison, the operator determines that the pair of patches match, then the operator can conclude that the input side processing of the printer has been correctly configured. If, however, they do not match, then the printer has not been configured correctly. In the contemplated embodiments of the invention, “input side configuration” includes the route taken to process device dependent colors, such as by direct copying, by using PostScript rules or by using an input profile.

The steps of the method as set forth in FIGS. 3(a) and 3(b) ensures that an identical calibration is applied to all device independent and device dependent colors. As a result, the occurrence of a difference between two patches is avoided. As shown in FIG. 3(a), the selected output profile may or may not be used based on the flow of device dependent colors that is followed. The decision to use an output profile or not, or the selection of the output profile, should not, therefore, cause a difference between the two patches in each pair. As a result, it is not a pre-requisite of the contemplated embodiments of the invention to check the use of the correct output profile prior to validating the configuration of the input side.

While the invention has been particularly shown and described with reference to exemplary embodiments thereof, it will be understood by those skilled in the art that various changes in form and details may be made therein without departing from the spirit and scope of the invention.

1. A method for confirming correct selection of an input profile of a printer for printing a color print, comprising:
encoding a plurality of color patches within a page description;
encoding one of each pair of color patches in the plurality of patches using a device independent color space;
encoding another one of the pair of patches in the plurality of patches using a device dependent space;
outputting the plurality of patches for visual display to a user, and
comparing the plurality of patches to determine whether the pairs of patches match.

2. The method of claim 1, wherein said outputting step comprises printing the plurality of patches next to each other on print media.

3. The method of claim 2, wherein the print media is paper.

4. The method of claim 2, wherein said outputting step comprises displaying the plurality of patches next to each other on a display monitor.

5. The method of claim 1, wherein the step of encoding each pair of color patches in the plurality of patches comprises placing an EPS file on a page by way of a design application;
wherein the EPS file is placed on the page such that it is printed near an outer edge of the page.

6. The method of claim 1, further comprising the steps of:
creating at least one of a Postscripts file and a PDF file of a document; and
processing the plurality of patches based on a color space in which each patch is defined and a device color space to which the patches are output.

7. The method of claim 6, further comprising the step of:
entering the file into a pre-press workflow that includes an imposition program.

8. The method of claim 6, further comprising the step of:
transforming device independent patches into an output device color space.

9. The method of claim 6, further comprising the steps of:
processing colors of device dependent patches directly as device code values when the color spaces of the patches and the device use identical colorants.

10. The method of claim 6, further comprising the step of:
transforming a color of device dependent patches directly into the output device color space.

11. The method of claim 6, further comprising the step of:
transforming device dependent patches into device independent patches, if color management is being used by a RIP.

12. The method of claim 11, wherein said transforming step is performed by way of an ICC profile to provide a colorimetric description of the device dependent space.

13. The method of claim 8, further comprising the step of:
transforming device independent color values into the output device color space using an output profile.

14. The method of claim 11, further comprising the step of:
transforming device independent color values into the output device color space using an output profile.

15. The method of claim 13, further comprising the steps of:
adding calibrations to colorant values in the output device color space; and
printing resultant values for comparison of the patches by the user.

16. The method of claim 14, further comprising the steps of:
adding calibrations to colorant values in the device output space; and
printing resultant values for visual comparison of the patches by the user.

17. The method of claim 9, further comprising the steps of:
adding calibrations to colorant values in the device output space; and
printing resultant values for visual comparison of the patches by the user.

18. The method of claim 10, further comprising the steps of:
adding calibrations to colorant values in the device output space; and
printing resultant values for visual comparison of the patches by the user.

19. The method of claim 4, wherein the design application is one of Adobe Illustrator®, Adobe InDesign® and QuarkXpress®.
